(19) United States
(12) Patent Application Publication
(10) Pub. No.: US 2014/0040154 A1
(43) Pub. Date: Feb. 6, 2014

(54) Defamation Avoiding System and Process to Identify Pattern Crimes

(71) Applicant: Steven C. Webb, Philadelphia, PA (US)

(72) Inventor: Steven C. Webb, Philadelphia, PA (US)

(21) Appl. No.: 13/958,939

(22) Filed: Aug. 5, 2013

Related U.S. Application Data
(60) Provisional application No. 61/680,226, filed on Aug. 6, 2012.

(51) Int. Cl. G06Q 50/26; G06F 21/62

(52) U.S. Cl. CPC G06Q 50/265; G06F 21/6245
USPC 705/325

(57) ABSTRACT

A system and process performed by the system for identifying and tracking perpetrators of any of various types of crimes, including bullying, child pornography, sexual assault and rape, in reports which are anonymously reported to the system. The perpetrators can be of various categories, such as formally convicted, and/or formally charged and not convicted, and/or never been charged or not yet been caught, and therefore are without prior convictions or criminal records and are thereby not on law enforcement's radar. The system and process relies upon the reporting by a victim or a witness of information pertinent to an alleged criminal event. The identity of each reporting victim is never known to the system, unless the victim or witness goes to the police. The system uses a “double blind” method to protect the victim and certain details of the reported incident.

### RELATED APPLICATIONS

This application claims priority to U.S. Provisional Application No. 61/680,226, filed Aug. 6, 2012, and titled Defamation Avoiding System and Process to Identify Pattern Crimes. The disclosure of that Provisional Application is incorporated herein by reference, as if repeated herein in-full.

### BACKGROUND OF THE INVENTION

The present invention is directed to a computerized reporting system for taking in data and storing it anonymously, and then analyzing the reported data against other reports for common patterns. This has never been done before.

Many pattern crimes, especially crimes involving sexual violence, go largely under reported. Generally with such sexual crimes, the witness or victim is alone during the event. A fear or hesitation to report the event often occurs because the victim and the witness or witnesses are required to go forward alone, and/or they do not know that there are other victims of the same perpetrator or group of perpetrators. The experience is traumatic and in many cases the chance of achieving justice is difficult, or nonexistent, due to the lack of tools and processes currently available to the public. These factors are more prevalent when the victim is a minor, as protocol for handling these reports is often vague which results in uncomfortable situations for the person who has been victimized. This often leads to the failure to obtain a successful prosecution.

On the other hand, individuals are sometimes wrongly accused. Once authorities are notified, the accused perpetrator's identity is published and a wrongly accused individual can be defamed resulting in a civil suit against the authorities. This can occur more often where the reporting authority is a school or a university official, a sports coach or trainer, a club member, a scouting leader troop, a camp counselor, a coach, or other activity association member. The fear of a retaliatory lawsuit resulting from an erroneous accusation causes a potential reporting person, i.e., “whistle blower”, from refraining to report an incident or physical event. This can occur even with internet bullying or other types of bullying.

Over 200,000 rapes and sexual assaults are perpetrated in the United States every year; while certain populations, such as students and military personnel, are unduly represented in these numbers, no population is untouched by this scourge. As awful and commonplace as the reality behind these statistics is, it represents an improvement over the situation just ten or twenty years ago. Advances in information and communication technologies (ICTs) and DNA databases, and improved policing and victim support have brought US sexual assaults down to their lowest historical levels ever. Yet sexual assault still remains persistently prevalent and pervasive. Police and prosecutors have become exceptionally effective at apprehending convicted sexual offenders when they re-offend, and at matching their DNA to unsolved crimes. However one big hole remains in the enforcement matrix, which remains to be filled: identifying and catching the un-convicted sexual offender.

Offenders with no prior convictions operate under the police radar. They typically are repeat offenders who have “gotten away with it” before, numerous times: they take advantage of an alarming and disturbing fact: the majority of rapes and sexual assaults go unreported! The U.S. Bureau of Justice Statistics (BJS), of the U.S. Department of Justice, reports that the majority of rapes and sexual assaults perpetrated against women and girls in the Untied Stated between 1992 and 2000 were not reported to the police. Only 36 percent of rapes, 34 percent of attempted rapes, and 26 percent of sexual assaults were reported. According to academic studies, two of the biggest barriers to getting rape victims to report the crimes are (1) a concern with confidentiality and (2) a fear of not being believed. For women, the need for confidentiality is often related to a fear of retaliation by the perpetrator. Keep in mind that the majority of rape victims know their attacker. It is not difficult to see the linkages between these factors. If the victim is not believed, the attacker goes unpunished and remains in the position to intimidate and harm his victim(s) further. Even when the victim does not know the perpetrator, or does not fear retaliation, the feeling that it is the victim's word against the perpetrator's word can make a victim reluctant to go through the additional trauma of reliving the attack in court, and in public. What has been lacking until now is a state-of-the-art solution to encourage victims to report the crimes with confidence that the information can be provided safely and beneficially.

### SUMMARY OF THE INVENTION

An object of the present invention is to provide a system to anonymously receive information and/or data about actual and alleged criminal events, from personal electronic devices transmitting the information over the Internet.

Many pattern crimes (especially sexual violence) are largely under reported because of witnesses going forward alone or not knowing if there are other victims of the same perpetrator or group of perpetrators. The experience is traumatic and in many cases the chance of getting justice is difficult, or nonexistent, due to the lack of tools and processes currently available to the public.

The present invention uses a hardware and a software system, with communications over the Internet, to provide an opportunity for victims to anonymously enter information relating to these crimes such as the name of the perpetrator, a license plate number, a phone number, any email contacts, an address, and any other information. This information is anonymously entered into a database which can process it and identify patterns including a common perpetrator(s) to multiple victims, regardless of social or geographic boundaries, without identifying the perpetrator prematurely and without solid legal justification and supportive proof. Slander and defamation of character issues are avoided and the history of activities accumulated is not directly released.

Victims supply criminal incident related information, by making an anonymous report. Each report is identified by a “report text identification” number only. That report identification number becomes the victim's pseudo identification. But the identification number identifies the report and not the victim. The report text identification acts as the victim's identification assuring complete anonymity for the victim unless the victim chooses to make a police report. Each report is also assigned a “report matching text identifier”. This report matching text identification becomes a cross-reference to a report to minimize errors in reporting.

Reports can be verified by a professional, if a victim later elects to be counseled by a selected state licensed professional on a confidential basis. In counseling with a professional, the victim can be observed and the story verified. Such counseling can reduce false reports from producing false positive results when analyzing for common or duplicate data between different reports. These professionals may belong to a direct network or can be involved with an integrated network system. The victim may seek the guidance of a doctor, therapist, private investigator or other appropriate professional(s) who can interview them about their victimization under the protection of legal confidentiality of a patient. The professional can verify the sincerity of the patient's/victim's claims without passing on any slanderous information. Having done so, the professional assigns a randomly generated Professional Network (Pro-Net) patient identification (number) that will be recognized by the central system server.

When the existence of present invention becomes publicly knowledge, that information may act as a deterrent to reduce pattern crimes, while providing relief to millions of victims who have few other options. It can also act as a statistical aid in the process of identifying jurisdictions and frequency of occurrence of specific crime patterns with statistical perpetrator and crime incidence characteristics.

Anyone who believes they were victimized anywhere, can enter information into a common Internet portal, and provide crime specific and social group specific or area specific information without establishing a personal profile or supplying personal identification.

The victims will be able to access the status of their report by keying in a report text identifier, i.e., a personal identification which has been blindly provided, and which was assigned at the time of the report, and their Pro-Net identification number. Report status information can be obtained from a dedicated reporting portal access to the Internet.

When making a report, the victim provided information may be processed by entry portal, or grouped in any way including being ported into a common portal for analysis of any kind for pattern identification. Any part or all of the information may be encrypted to eliminate the exposure of information to another person when it is being transmitted over the Internet.

Once the information in is entered into the system offline server, a matching process identifies commonalities related to the victim's report with reports previously submitted by other victims, regardless of grouping. Potential common alleged perpetrator(s) are matched to multiple victims using various fields, where commonalities or patterns of criminal behavior are detected.

As indicated above, information can then be given to the victim(s) via a return report on a dedicated reporting Internet web page, or by other communication means elected by a victim. This information becomes available when the victim anonymously enters their personal identification and the Pro-Net identification number provided by the counseling professional. The report provides information on the number of records (reports) in the system addressing criminal incidents within the same jurisdiction, with the same or related criminal acts, with the same perpetrator information, and an amount of similar or related perpetrator information.

Victims are thereby anonymously informed of the size of the victim “pool” for the criminal incident they have reported.

Each law enforcement agency in the jurisdiction and adjacent jurisdictions to the location of the criminal incident reported by a victim is notified about the existence of a potential pattern crime, the number of victims involved, and the location of other law enforcement agencies being notified. During this notification no names of either the accused perpetrator or the victim(s) is disclosed. The law enforcement agency receives a report on a crime pattern and an associated suspected perpetrator identification number, thereby keeping the perpetrator's sensitive information protected until a victim comes forth. The law enforcement agency also receives a list of other law enforcement agencies contacted regarding the particular crime pattern report.

The invention includes Pattern Associated Crime Technology “modules”. For publication purposes it is called “Pattern Associated Crime Technology Suite (P.A.C.T.S.)

The purpose of the invention is to break the natural reluctance of a victim to come forward, be identified and accuse a perpetrator, whereby a victim may be subject to public ridicule, a natural shame, and a fear of reprisal from the accused, and from his/her family and friends.

No one aside from system administrators has access to reports until an actionable perpetrator pattern has been recognized. Even then the identity of each accused perpetrator and sensitive information associated with him/her is masked from the system administrators. This sensitive information is not unmasked unless a victim has come forward and identified an accused perpetrator, or in the alternative, law enforcement obtains a court order. Even in this latter circumstance, law enforcement usually will not arrest an accused perpetrator unless he confesses or a victim appears to identify and accuse him.

The database built with the present invention, helps authorities to connect additional anonymous victims to an apprehended perpetrator, across time and jurisdictions, which the perpetrator might otherwise be missed. This becomes important in giving closure to victims, and in making sure that criminals receive the appropriated punishment. In high-profile cases, the media often contributes to the information needed by the authorities. In the more frequently occurring, less media intense cases, the present invention accumulates data for determining criminal patterns.

The P.A.C.T.S. of the present invention is not intended to negate the need for remedial and corrective action to be taken in all organizations that have not fully implemented policies and programs representing best practice, including: clear and strong anti-assault policies; accessibility to information, training and education; public information campaigns; crisis centers; prompt, transparent, accurate and accessible reporting: and long term counseling for the victim. The implementation of the present invention will support individual organizations' efforts with a multi-jurisdictional, multi-stakeholder platform that can make a powerful impact even in those institutions and environments that have thus far failed to implement the best practices. But it will not replace those institutions.

If two or more victims describe (report) the same individual or the same criminal event, a a pattern is then found (declared). This allows the system to identify as many factors as are available in the system server database about the perpetrator and the crime. The system report results in all victims involved being informed that they are not alone. Hopefully they will become more comfortable and confident in reporting their case to the authorities. Depending on the specific criteria previously entered by the victims, this is often timed in conjunction with a notification to the law enforcement authorities directly.

Each victim's report is captured piecemeal and stored as individual pages on a plurality of online database servers to which each page is randomly assigned. An offline processing (system) server retrieves report pages from each online database server and assembles the information as a complete report.

The system online web homepage is the portal through which each reporting victim or witness enters criminal event related information. An assigned personal identification number (report text identifier) and an assigned report matching text identifier number is associated with a report and each page of a report or a piecemeal page of a report.

A personal identification number (report text identifier) and a report matching text identifier are each comprised of string of characters being combinations of numbers, upper and lower case letters, and characters found on a standard keyboard. Each is randomly generated in a string of from 16 to 128 characters long. Each personal and report text identification number is permanently assigned to a specific report, and both are needed to file a supplemental report on the particular criminal event.

The report on a particular criminal event is transmitted piecemeal, as it is generated, to randomly chosen separate online databases. Each piece-meal report “page” is sent to a separate database. As it is sent, each piecemeal report page is assigned a reassembling identification number, This reassembling identification number is used to identify the report to which a piecemeal page belongs, so that a specific report can be assembled from the piecemeal data obtained from each online database.. This report reassembling identification number assigned to each “page” is used to reassemble the sections of a report into a complete set of data, and in the instance of a supplemental report to accumulate additional data specific to the report when that data is submitted at a different time.

Piecemeal pages sent to and retrieved from online databases and stored in these online databases, carry the reassembling identification number which is encrypted. This encryption is generated by a different algorithm each day from selected characters from the personal identification number (report text identifier) string and the matching text report identification number string first assigned to a report. When pages or piecemeal pages are on the Internet the report text identifier and the matching text report identifier are masked from interlopers and hackers.

The offline analysis (system) server periodically retrieves the data from each of the online databases to load it into the analysis system server. As the data is captured by the analysis server and determined to be secure, the record of the retrieved data in the online database server is erased by a security application.

Data retrieved into the analysis server is assembled into a report according to the active reassembling identification number for that day. Once the retrieved data in an analysis server is placed into the proper “report file”, the report reassembling identification number is no longer needed for that data.

The information (data) obtained from the reporting person is characterized as “sensitive” or “non-sensitive”. Sensitive information includes the alleged perpetrator's name and other personal information, such as address, telephone, email and similar information. When the piecemeal “pages” are transmitted to, stored in, and retrieved from the online databases, this sensitive information is “masked” so that an interloper or hacker can not read it.

The analysis (system) server assembles each report and analyzes, i.e., compares data in the answers with all other reports in the system. Reports with duplicating answers, i.e., two or more being the same, are grouped into a first subset. Then this first subset is compared for duplications of the sensitive data. Reports with duplicating answers are grouped into a second subset. This process is repeated until there are no longer any duplication of answers found.

Each victim is encouraged to consult a state licensed professional who is well trained in victim counseling. This professional may be chosen from a list of professionals registered with the system. Having visited the Pro-Net professional, the victim is assigned a Pro-Net identification number which is active for 90 days. This Pro-Net identification number and the victim's personal identification number (report text identifier) are required for a victim to access the victim's report status on a dedicated reporting website.

The analysis server makes two reports available. The first report is to a victim reporting page, which provides the status of the particular victim's report. That status report notifies the victim of the number of identical and very similar reports in the system with respect to the criminal event and the alleged perpetrator information.

The second report is sent to appropriate law enforcement jurisdictions. This report notifies the law enforcement agencies of the number of reported incidences involving specific criminal behavior which have been reported for the jurisdiction. This report is also sent to adjacent jurisdictions and a list of jurisdictions receiving the report is included.

### BRIEF DESCRIPTION OF THE DRAWINGS

The features, advantages and operation of the present invention will become readily apparent and further understood from a reading of the following detailed description with the accompanying drawings, in which like numerals refer to like elements, and in which:

FIG. 1 is a block diagram of the communications hardware and the communications paths used by that hardware in the present invention;

FIG. 2 is a block diagram on a macro level of the process steps carried out by the invention;

FIG. 3 is a more detailed block diagram of the process shown in FIG. 2;

FIG. 4 is a block diagram of the process carried out by the analysis (system) server;

FIG. 5 is an even more detailed block diagram of the process shown in FIG. 3;

FIG. 6 is a block diagram for process steps for entering an amended or supplementing an existing report;

FIGS. 8a and 8b are detailed block diagrams of process steps for transferring pages and piecemeal pages, reassembling a report and reporting to law enforcement agencies;

FIG. 9 is an example of an initial screen presentation to a victim upon entering the system homepage for reporting;

FIG. 10 shows a second screen presentation for assigning a report text identifier (personal identification) and a report matching text identifier to the impending report;

FIGS. 11-21 show a series of screens which walk a victim though information requested, wherein the victim enters data by clicking on buttons or blocks or by pull down screens and elections from each pull down screen; and

FIG. 22 shows the final signoff screen with further instructions to the victim reporting.

### DETAILED DESCRIPTION OF THE INVENTION

The present invention is a hardware and software implemented reporting system for anonymously reporting an alleged criminal incident. Communications are carried out over the Internet between a personal electronic device operated by a victim and a system server which drives Internet communications. The system operates an Internet portal homepage through which information is communicated from a victim.

A victim's report is stored and compared with all other victim reports for commonality of information in order to determine criminal patterns as a function of type of criminal incident, victim type, perpetrator type, perpetrator personal information, crime location, and other information useful in categorizing the criminal incident.

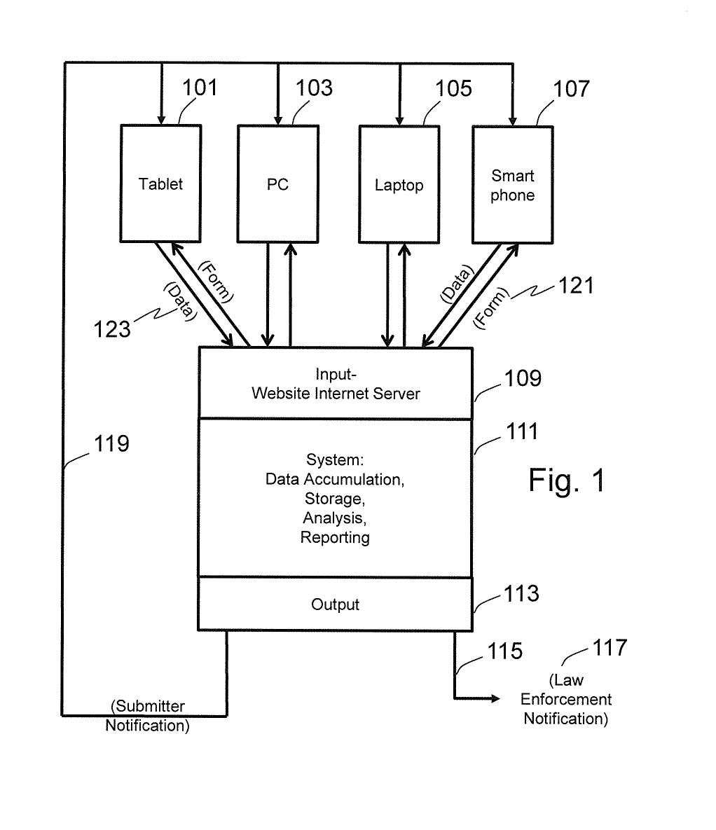

The system of the present invention requires the reporting victim to have access to an electronic device, FIG. 1, such as a tablet computer 101, a personal computer 103, a laptop computer 105, or a smart phone 107. The victim logs on the Internet with such a device and logs onto the homepage 109 of the system network. This homepage 109 is the input to the system server 111. The homepage is the website input to the system server 111 connected to the Internet.

In operation, the system server 111 accumulates data about each criminal incident reported, stores pages of each of these reports, assembles report data into a complete report “string”, analyzes each report against every report stored ,and reports on crime patterns.

The report on crime patterns is made through an output server 113 through an Internet link 115 to law enforcement agencies 117. The output server 113 also notifies a respective victim's electronic device 101, 103, 105, 107 through an Internet connection 119 to the victim.

The system input 109 sends forms via an Internet connection 121 to each victim's device to solicit information about the criminal incident being reported. The victim responds and sends answers or selects responses from a pull-down or bank of buttons. This data is sent to the input portal 109 via an Internet connection 123.

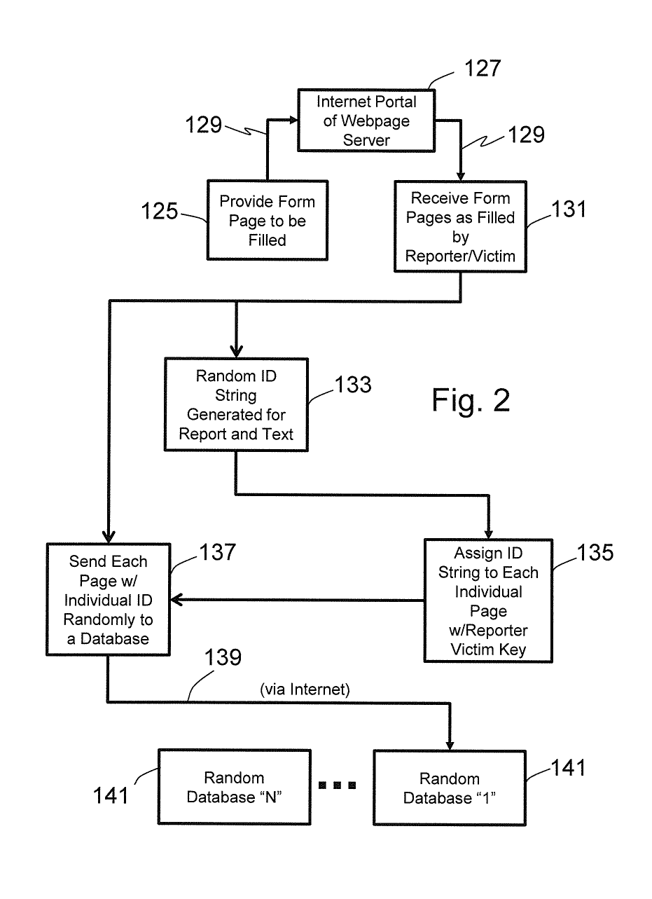

FIG. 2 shows the process steps at a macro level carried out by the system hardware and software. When a victim logs on, a series of announcements and forms are provided 125 through the Internet portal 127 of the webpage server over an Internet connection 129 to the victim. Responses are received 131 over an Internet connection 129 from the victim reporting the criminal incident. The responses received 131 have been reported by the victim addressing form pages to be filled out.

When the first page of a report is received, a random generator 133 generates two identification strings of characters, each being between 16 and 128 characters long. A first identification is the report text identifier (personal identification) for the particular report. The second identification is the report matching text identifier which is used for encryption and security purposes. Both the randomly generated report text identifier and the report matching text identifier are used to encrypt an identification string for pages of the particular report 135. This encryption is generated by an algorithm generated for that day, which creates the encrypted page identification from selected characters from each of the report text identifier and the matching text identifier. This encrypted identifier is then assigned 135 to each received page, or received piecemeal page, or received section of the report. Once the encrypted identification is assigned, the respective individual pages, piecemeal page, or section is sent 137, via the Internet 139 to a randomly selected online database 141 where an individual report page is stored. No two report pages are stored in the same online database 141. No report text identification and no matching text identification is present with an individual page or in an online database 141.

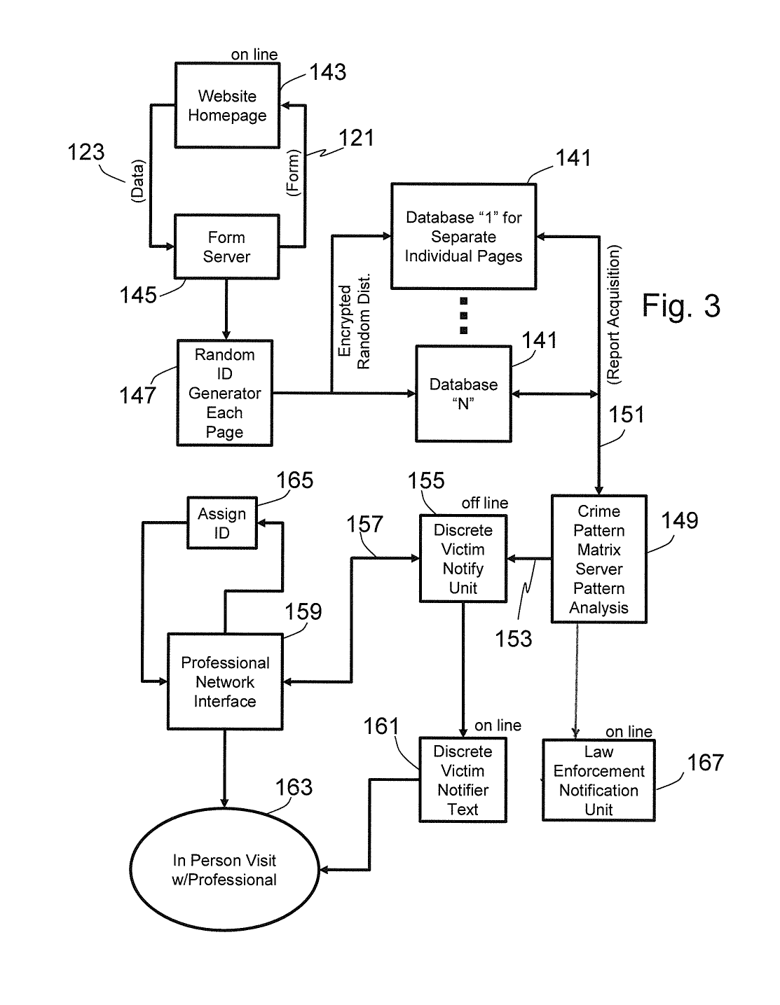

FIG. 3 shows hardware used to implement the process of FIG. 2. The Internet portal 127 of FIG. 2 is implemented by creating an interactive homepage 143. This online homepage 143 receives forms 121 seeking crime incident information (data) and sends this data 123 to the form server 145. Each page received by the form server 145 is passed onto the random identification generator 147 which generates the encrypted identification number assigned to each page of a particular report which is then sent over the Internet 139 to a randomly selected one of a plurality of online databases 141.

The system server 111, of FIG. 1, includes an offline crime pattern matrix server 149, FIG. 3, for crime incident pattern analysis. This crime pattern matrix server 149 periodically logs onto the Internet 151 for crime incident report page acquisition from each of the online databases 141. Once a page is acquired from a database, the record on that database 141 is erased.

The crime pattern matrix server 149 assembles each report from its individual pages using the encrypted page identification 135. Once a report page is stored in the crime pattern matrix server 149, the encrypted identification associated with that page is removed and the pages are assembled into a report file according to the report text identifier and the report matching text identifier.

The crime pattern matrix server 149 has two-way communication 153 with an offline discrete victim notification unit 155. This notification unit 155 has two-way communication 157 with a professional network (Pro-Net) interface 159.

The offline discrete victim notification unit 155 is connected to an online notifier text unit 161 to provide notifier “text” to the respective victim. This unit 161 sends a text message to a victim suggesting he/she seek professional help from a professional network of victim care providers because the reported crime incident is not alone. The report indicates a crime pattern between the similarity of the facts of the particular reported incident and the facts of other reported incidents.

When a personal visit to a victim care provider, selected from a list of doctors, psychologists, psychiatrists, and counselors, occurs 163, and the victim care provider confirms that a crime incident occurred, the victim care provider accesses the professional network interface 159 for a Pro-Net victim identifier provided from a Pro-Net identifier generator 165.

In addition, the crime pattern matrix server 149 instructs an online law enforcement notification unit 167, via a connection thereto, to end a report to the appropriate law enforcement units about the determined crime pattern.

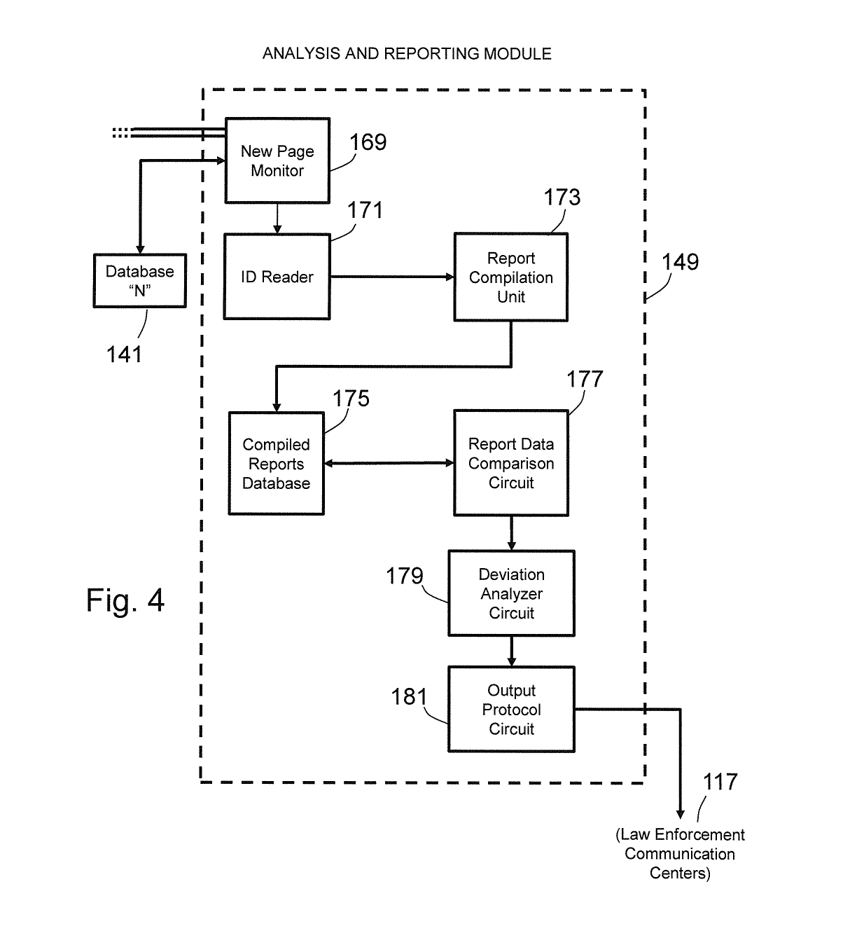

FIG. 4 shows the hardware within the crime pattern matrix server 149, which operates as an analysis and reporting module. A new page monitor 169 is connected online to each of the online databases 141 and monitors for the depositing of new pages. New pages are retrieved from each of the online databases 141 and passed onto an identification reader circuit 171 connected to the new page monitor 169. The identification reader re-crypts the encrypted page identification and identifies the report text identifier and the report matching text identifier for each page. Thereafter the respective page is sent to a report compilation unit 173 connected to the identifier reader circuit 171. Compiled reports are sent to a database 175 connected to the compilation unit 173. A report data comparison circuit 177 talks back and forth with the database 175. When there are duplications in the data found between any two reports, the data contained in each involved report is sent to a deviation analyzer circuit 179. The results out of this deviation analyzer circuit 179 are sent to an output protocol circuit 181 through a connection thereto. The output protocol circuit 181 determines the form and content of a statement (report) sent to law enforcement communication centers. A jurisdiction involved as the site of pattern of criminal incidents, the number and characters of the criminal incidents and other associative information is generated by the output protocol circuit while keeping the identity of the unknown victim and the identity of the known perpetrator are protected.

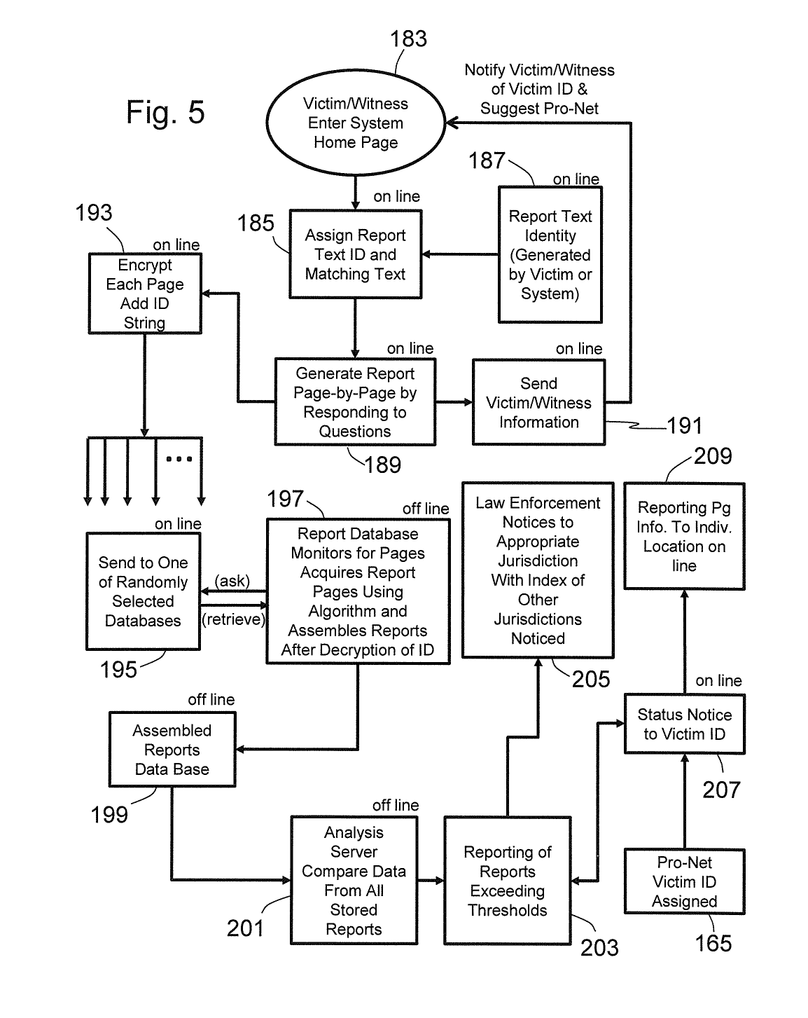

FIG. 5 shows a more detailed block diagram of the process steps carried out by the present invention. The process begins when a victim or witness enters the system homepage and the system assigns a report text identifier and a report matching text identifier to the victim or witness entry pages 185 from identifiers generated 187 by the system. Report pages are generated into piecemeal blocks of data 189 and the victim/witness is sent information 191 to the witness/victim logged into the system homepage 183. This information includes the identifiers (report text identifier and report matching identifier) and the suggestion to seek counseling from the network of professional.

Each piecemeal block of data generated 189 is assigned an encrypted identifier and then assigned 193 to one of a plurality of online databases. Each piecemeal block of data is retrieved from its online database and is assembled into a composite incident report 197. Assembled reports are stored 199 in an offline database from which reports are compared 201 duplication of information. Reports identified for duplicated facts are further compared for further comparisons 201 and a report summary is generated for reports exceeding a threshold for duplication 203. This information is sent 205 to law enforcement. When a Pro-Net victim identification has been assigned 165, that information and the duplication information 203 are used to send 207 status information to a separate dedicated online reporting page which displays 209 the information when a victim enters the proper identification (report text identifier and Pro-Net assigned identification.

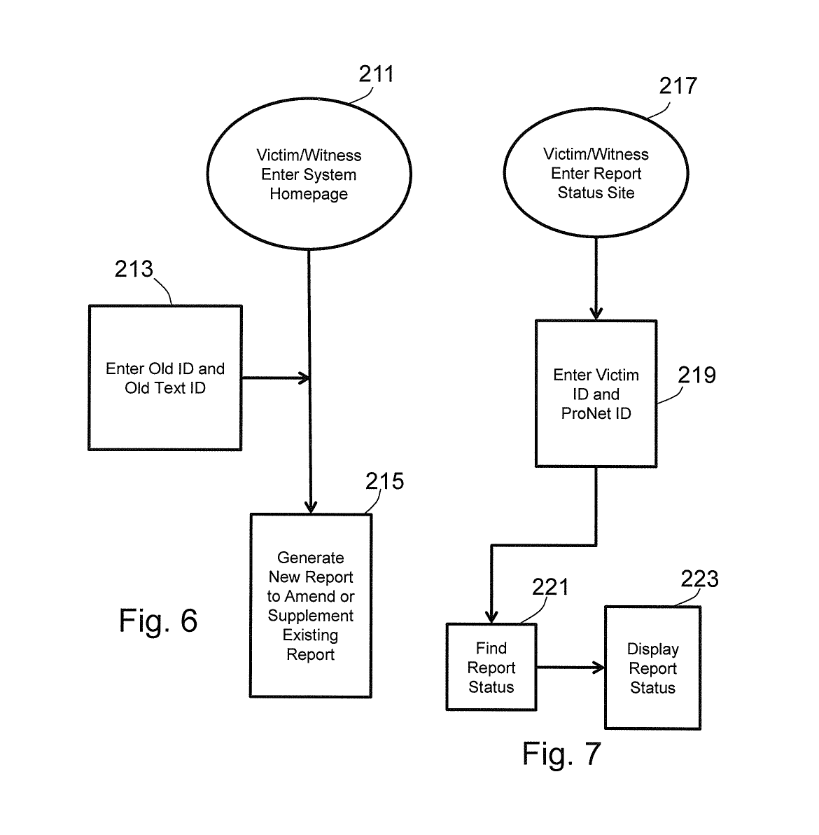

A witness or a victim can reenter 211 the reporting system homepage, FIG. 6, to correct, amend, or supplement a report. This is done by first entering the previously assigned identifiers (report text identifier and report matching identifier). Then the system provides the same pages, same questions and solicits data 215 in the same manner as previously provided. The victim responds as if providing an initial report. The previously submitted data is not disclosed to the victim.

A separate dedicated reporting site or location is given to each victim who can enter that site 217 to obtain a status report on the reported crime incident. Once both victim identifiers are entered 219, the report status for that individual is located 221 and displayed 223 to the individual.

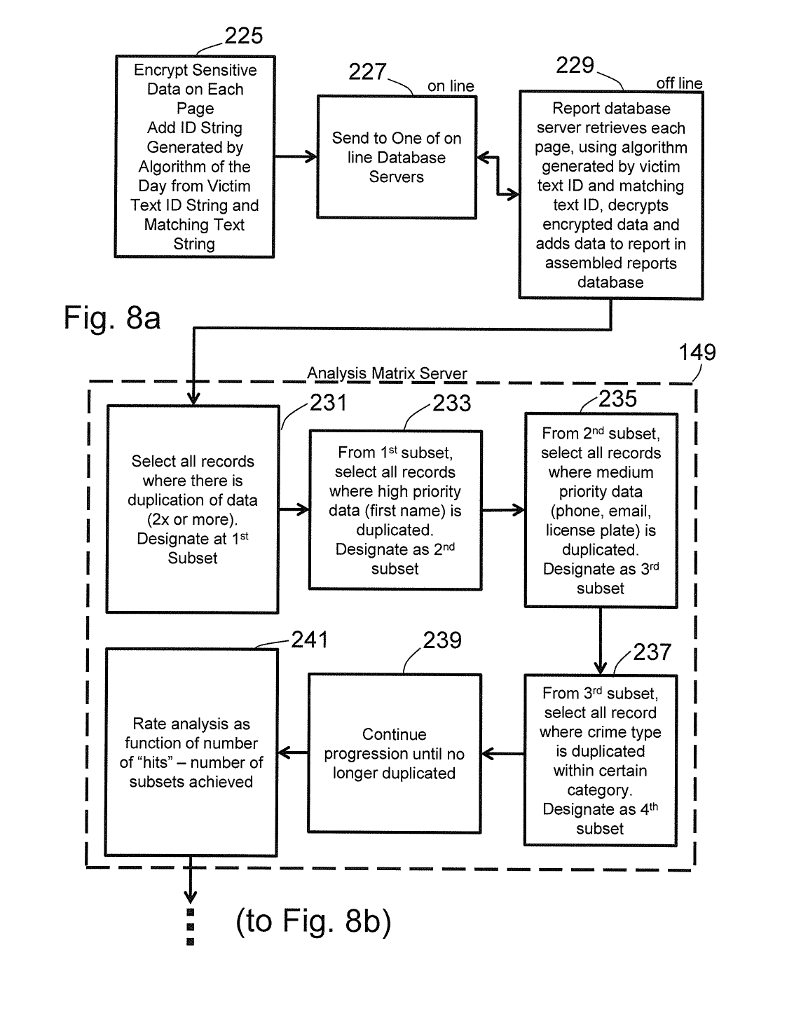

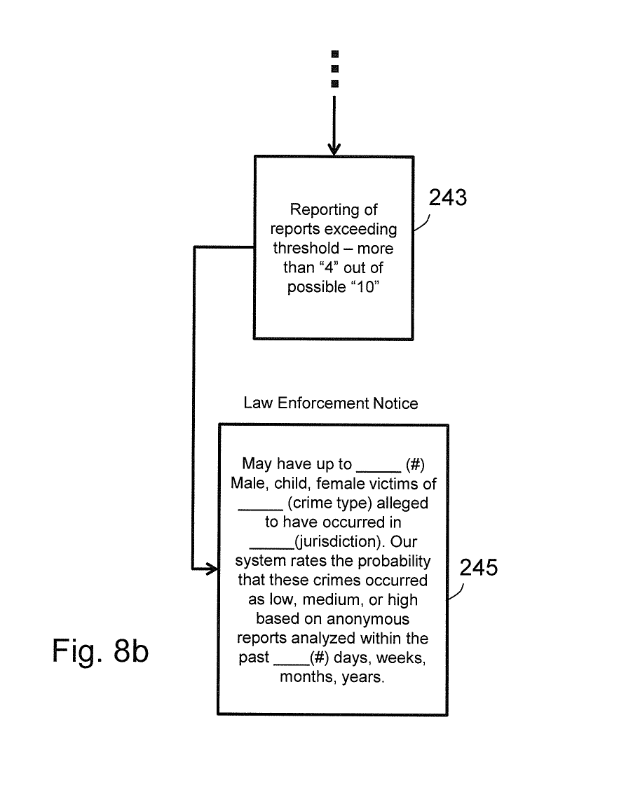

Precautions are taken by the system of the present invention to protect the identity of both the victim and the perpetrator in the database of crime data. The system operates as a “double-blind” information and reporting system. FIGS. 8a and 8b illustrate protective steps carried out by the system in protecting information which could lead to a slander or defamation issues. When data is to be transmitted online, sensitive information is encrypted or masked and a separate identifier is assigned to each data block. This information is sent to one of a plurality of unknown online databases, separately, so that no database will provide cognitive information 227. The online databases act as a buffer to protect the system offline server, which can randomly data query an online database and download information 229 which then is erased from the online database. This scheme is intended to protect the information and the transfer of information from hackers and interlopers.

Thereafter, the process continues offline, and is therefore generally secure. Records are interrogated and data compared offline and records for duplication of any kind, i.e., two or more answers and/or statements being duplicated. These records are designated into a first subset 231. This process of searching for duplication is repeated on the first subset to address high priority data. Records determined to have duplication are designated into a second subset 233. This process is then repeated on the second subset for medium priority data and duplication records are designated into a third subset 235. The process is conducted again on the third subset for duplications of crime category or jurisdiction. The duplication records are designated into a fourth subset 237. This process can be progressively continued until there is no longer duplication 239.

A report can be generated from the results creating any subset. Therefore the incidence of criminal incident information can be generated at many levels. A rating analysis 241 is conducted as a function of the number of hits each subset has achieved. Each possible report at a given level of duplication and the kind of criminal incident information relied upon can be evaluated as a function of a rating below or exceeding an assigned threshold 243. This threshold is adjustable as more is learned about crime patterns for each type of crime.

With this analysis, a more informative report can be generated 245 for law enforcement. Such reports can indicate the number of victims, the crime types, the victim type (male, child, female, etc), the jurisdiction or jurisdictions of the crimes, the probability (low, medium, high) of the accuracy of the information, and the time frame (days, weeks, months, years) of the crimes being reported.

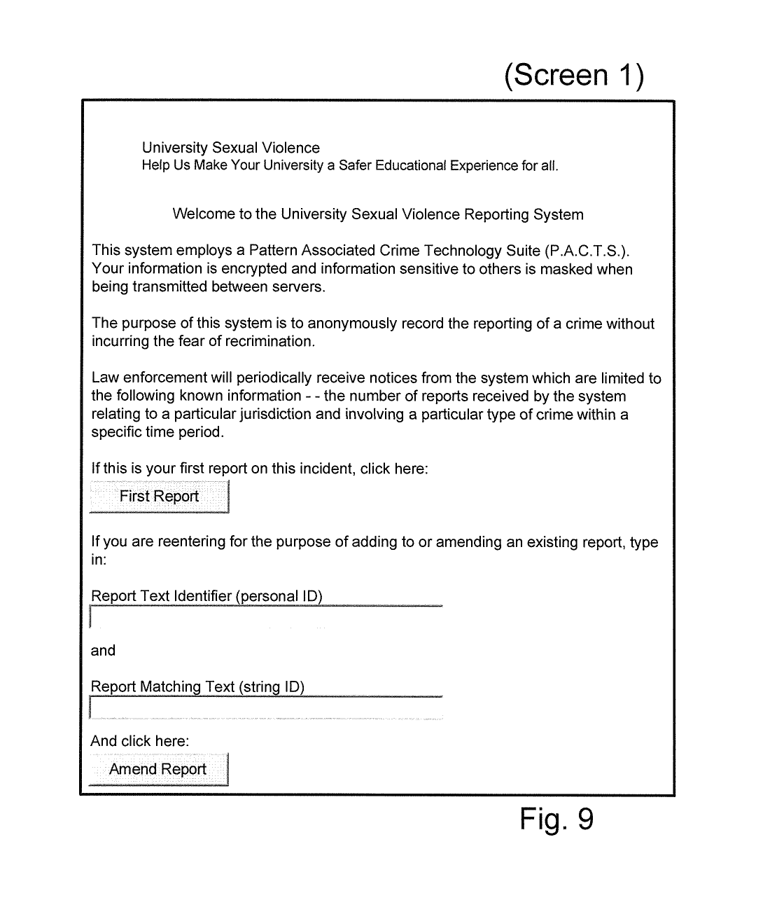

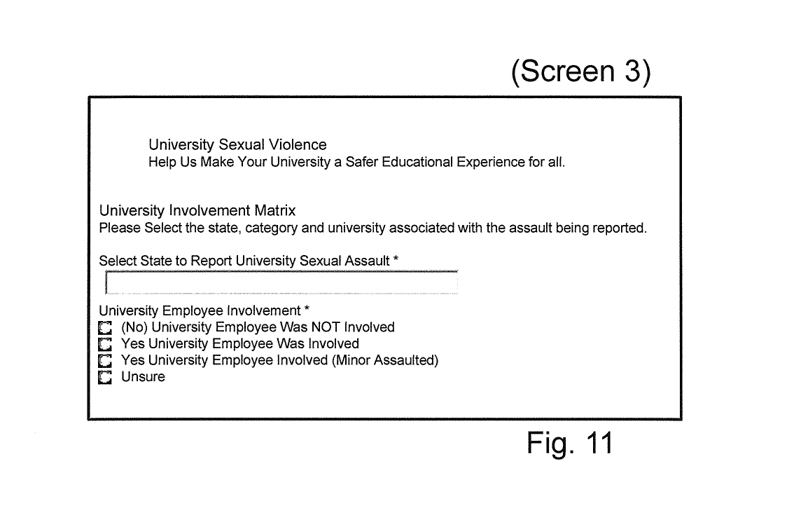

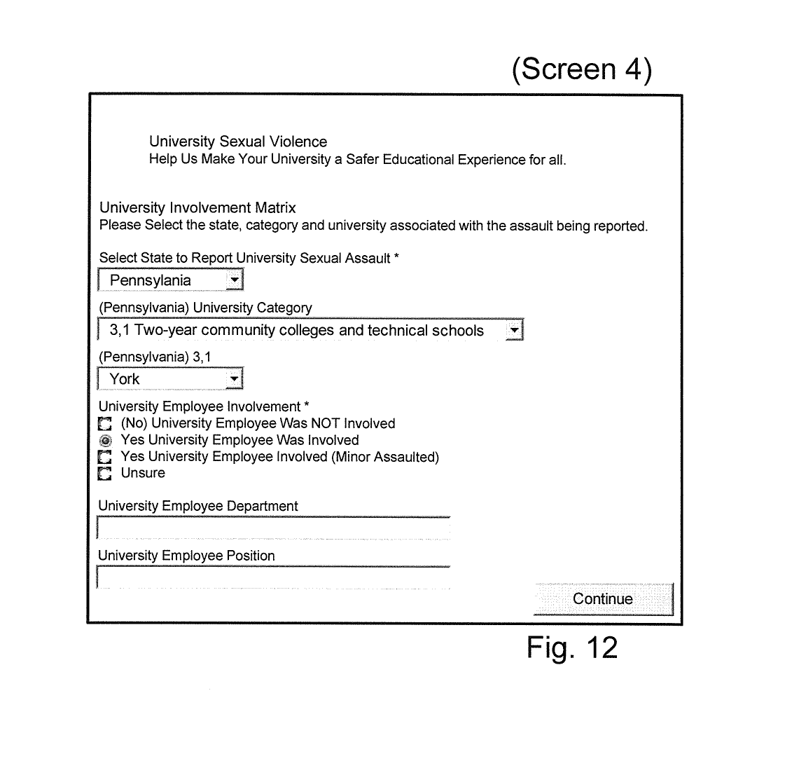

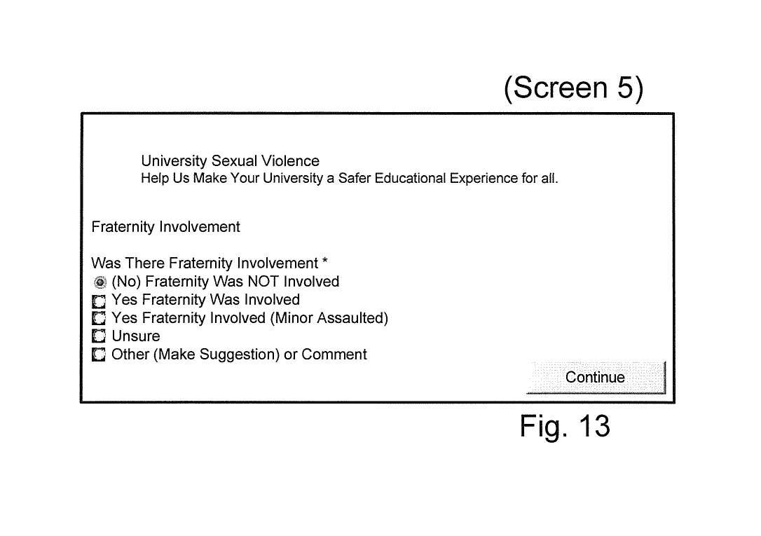

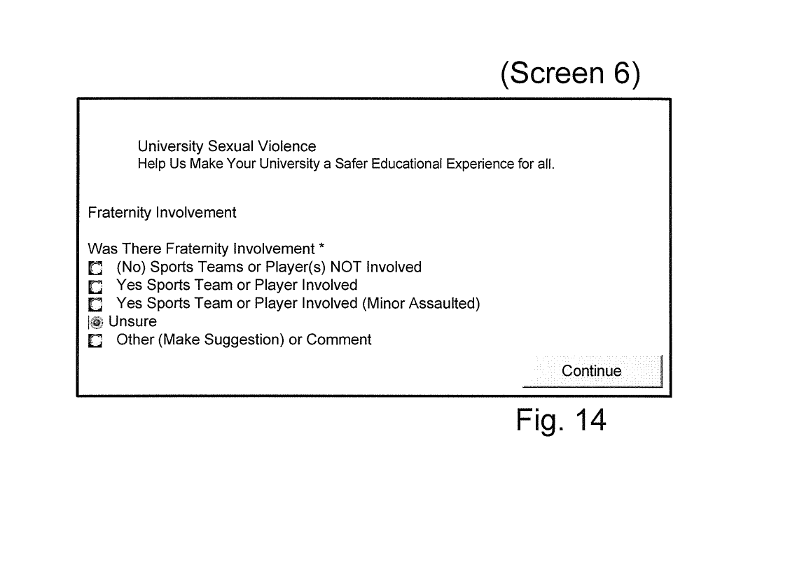

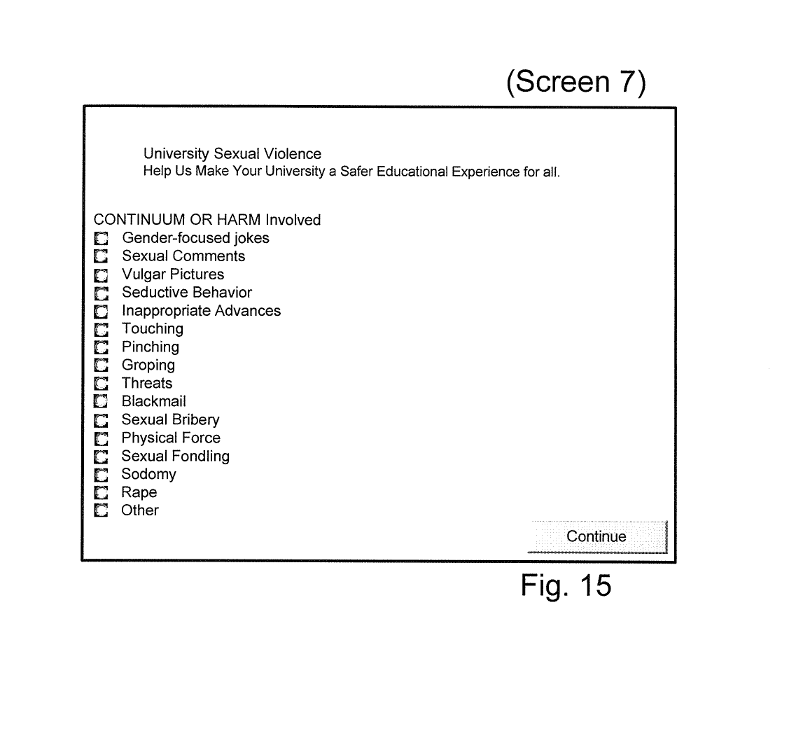

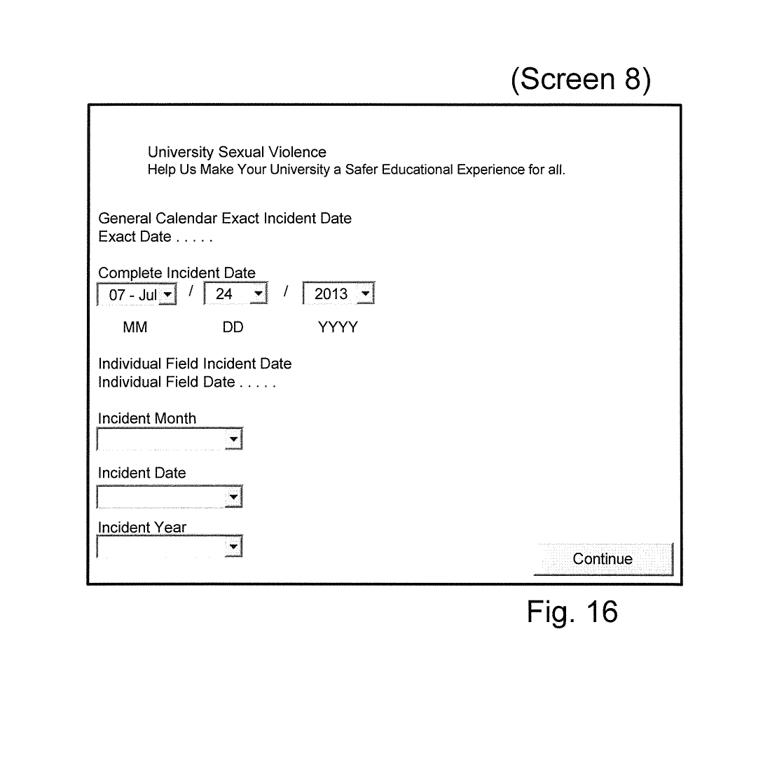

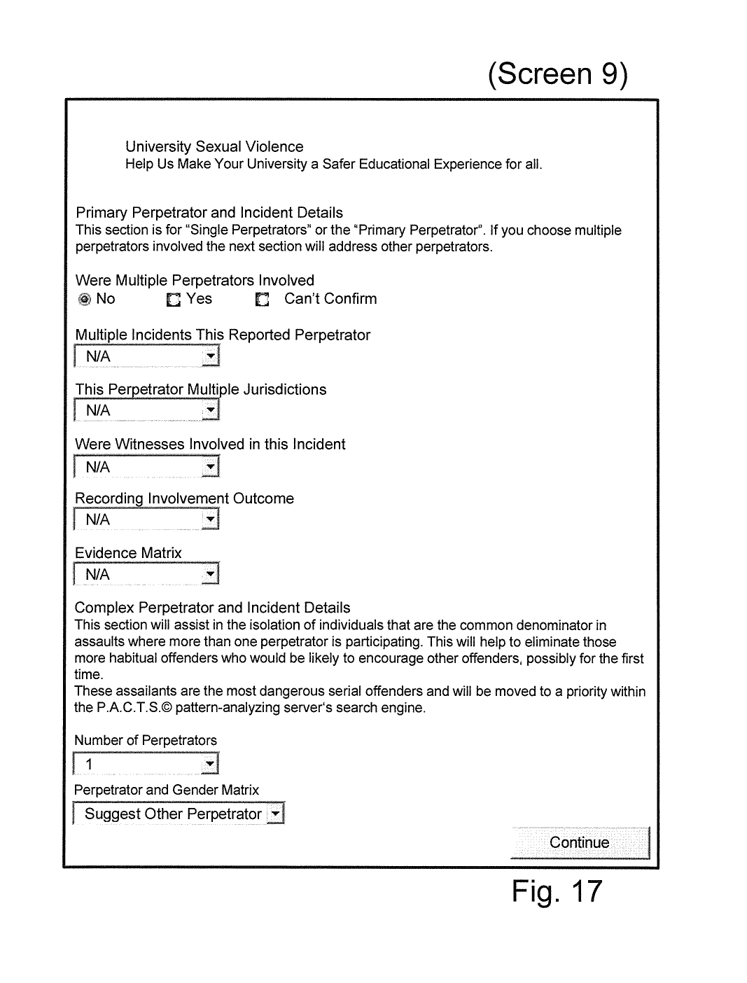

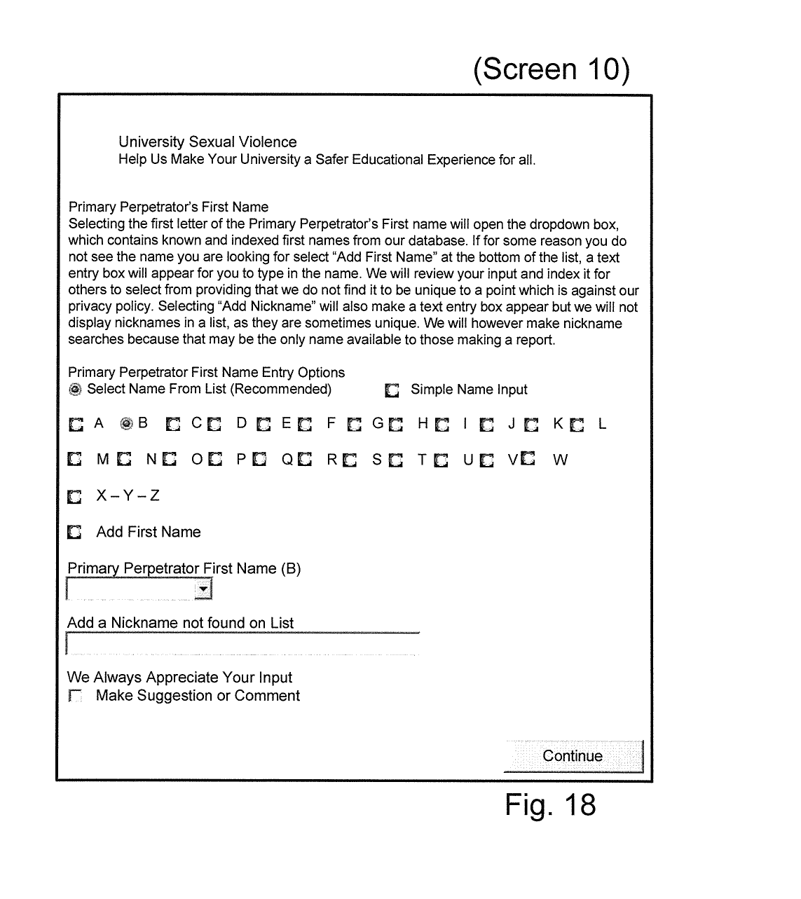

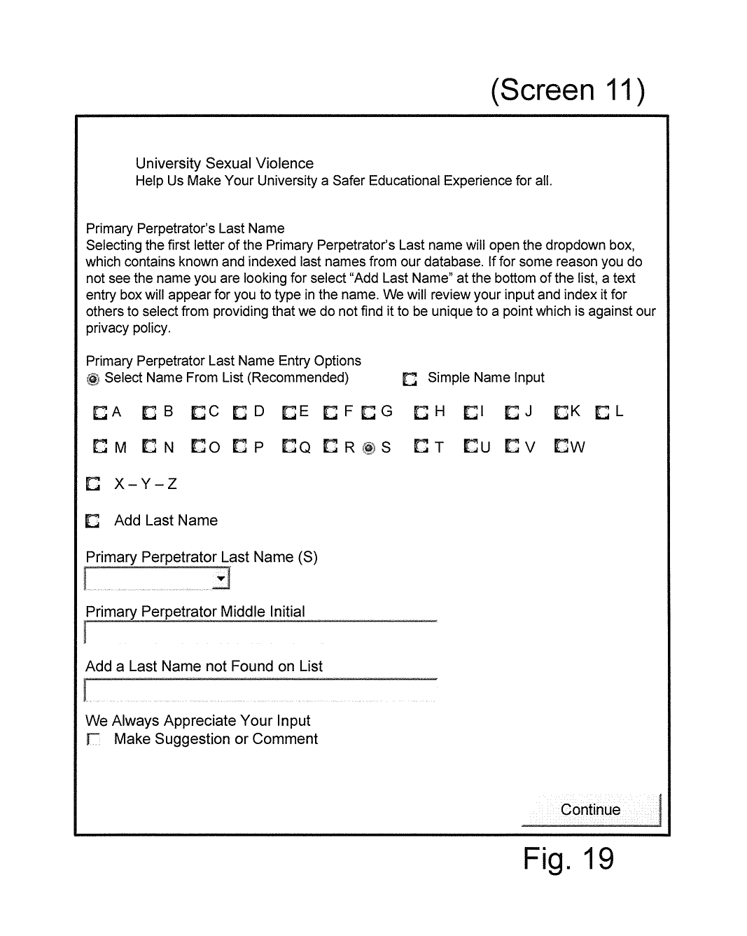

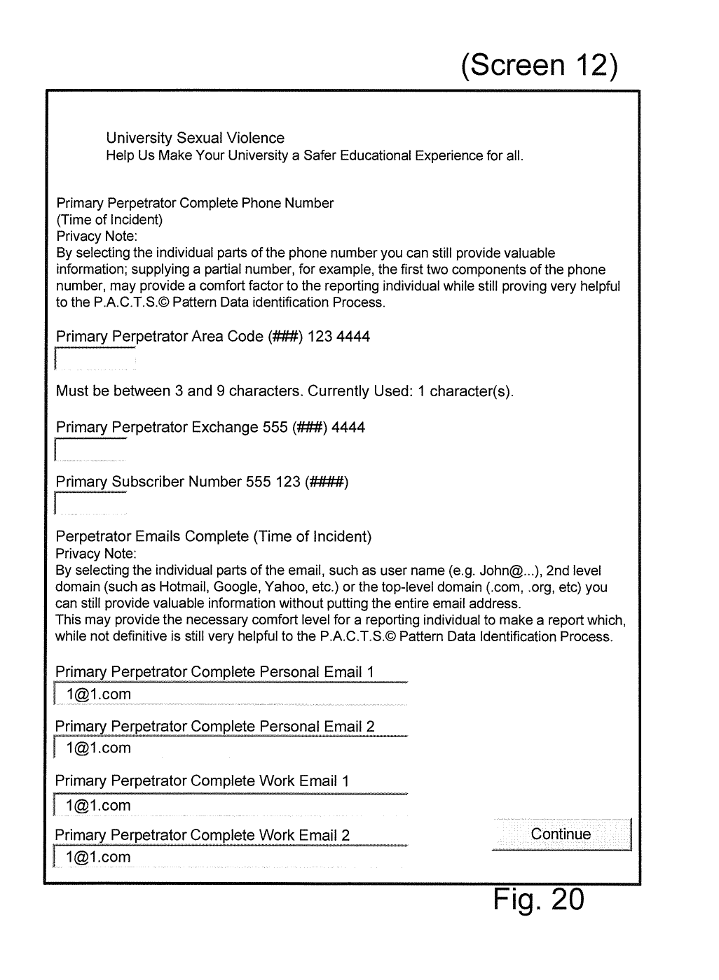

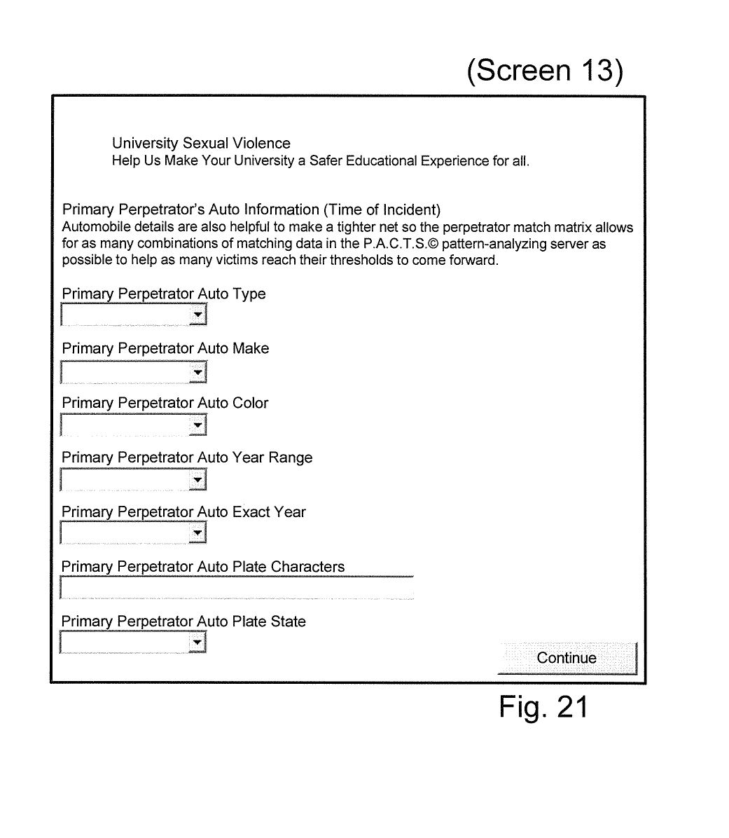

FIGS. 9-22 show a series of 14 screens, screen 1 through screen 14, for use in the present invention. While many different environments and many different types of criminal activity can be targeted, FIGS. 9-22 show the example, of addressing sexual violence in a university environment.

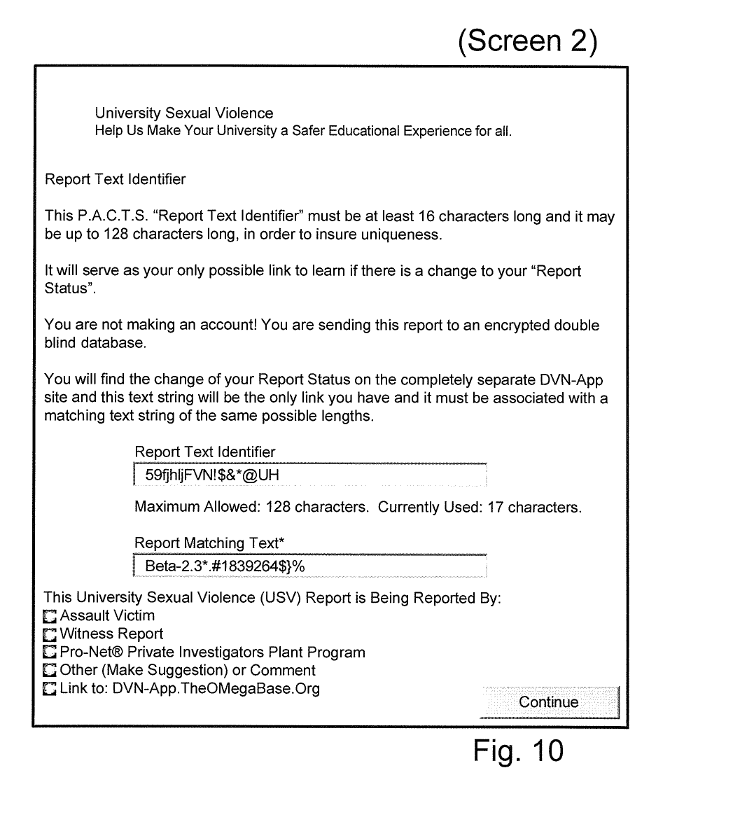

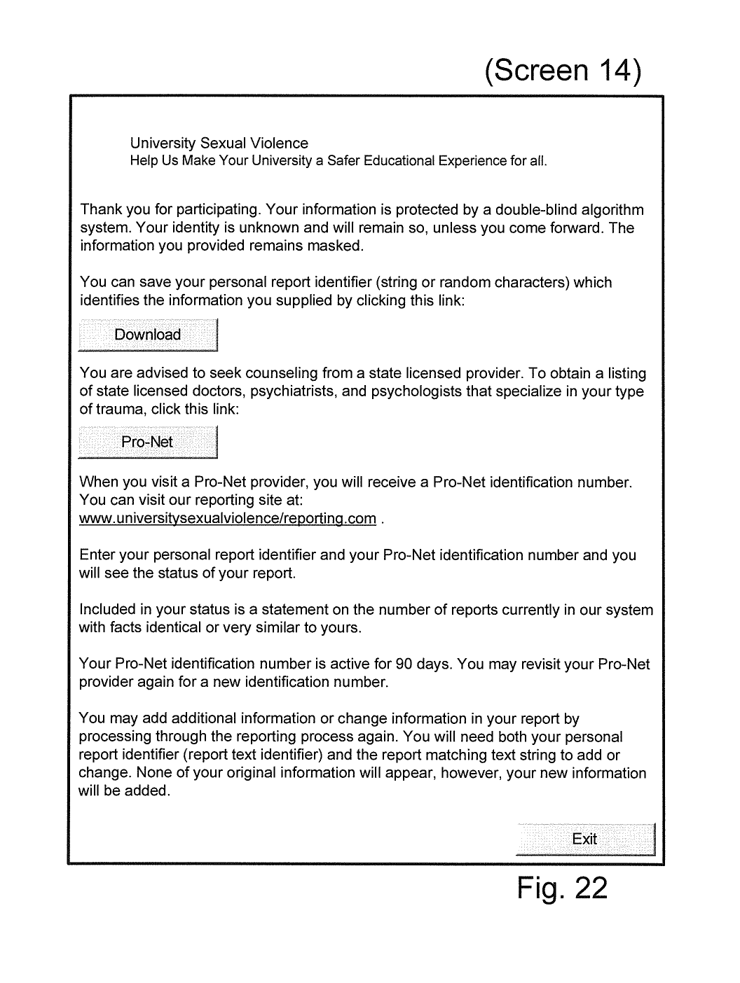

FIG. 9 shows an introductory entrance screen where the report text identifier and the report matching text identifier are supplied and the victim is interrogated for the report being an initial report or a follow-up or amended report. Clicking on a responding button submits the page and moves the report along to successive pages. The successive screens, FIGS. 10-21, progressively ask for more pertinent information. This is done to get the victim into completing the report without frightening the victim off by asking the name and address of the perpetrator in the beginning. FIG. 22 shows the concluding or sign-off screen. This screen provides information which a victim will need after a sign-off (logging off) of the report website.

Many changes can be made in the above-described invention without departing from the intent and scope thereof. It is therefore intended that the above description be read in the illustrative sense and not in the limiting sense. Substitutions and changes can be made while still being within the scope and intent of the invention and of the appended claims.

1. A defamation avoiding system to identify pattern crimes from reports transmitted over the Internet, comprising:
an Internet portal server connected to the Internet and being capable of receiving crime data from a plurality of Internet capable sources without the victim's identity;
a system server connected to said Internet server for accumulating data therefrom, storing and analyzing said data, and providing a report;
an output server connected to said system server and to the Internet for sending a report to law enforcement agencies and for selectively sending a notification to a selected one of said Internet capable sources.

2. The system of claim 1, wherein said Internet portal server includes;
a webpage server capable of presenting a succession of interactive form pages to be filled by a victim; and
a form server circuit connected to said webpage server for sending for pages on to the Internet and for receiving filled form pages from the Internet.

3. The system of claim 2, also including a random identification generator connect to said form server and receiving each filled page therefrom, and a plurality of online database devices connected via the Internet to said identification generator for receiving filled page data therefrom, each said filled page data having an encrypted identifier associated therewith and having crime perpetrator sensitive information masked.

4. The system of claim 3, also including:
a crime pattern matrix server connected via the Internet to said plurality of online database devices;
a law enforcement notification circuit connected to said crime pattern matrix server; and
a victim notification module connected to said crime pattern matrix server.

5. The system of claim 4, wherein said law enforcement notification circuit and said victim notification module are each independently connected to the Internet.

6. The system of claim 5, wherein said victim notification module is also connected to an interface portal module operating to connect to a network of licensed professionals for crime victim treatment.

7. The system of claim 6, wherein said crime matrix pattern server includes an analysis and reporting module comprising:
a monitor connected to the Internet for monitoring for new pages data in any of said plurality of online database devices for retrieving each new page data;
an identification reader decryption module connected to said new page monitor;
a report compilation module connected to receive the decrypted pages from said identification reader;
a database storage for storing compiled reports from said compilation unit;
a report data comparison circuit connected to said database storage;
a deviation analyzer circuit connected to said report data comparison circuit; and
an output protocol circuit connected to said deviation analyzer;
wherein said output protocol circuit is connected to the Internet for sending a report to law enforcement agencies.

8. A method for receiving crime incident information and identifying crime patterns in an online crime incident reporting environment while protecting the victim's identify and avoiding defamation issues regarding sensitive perpetrator information, comprising the steps of:
providing a homepage portal on the Internet through which a victim may anonymously report the facts of a crime incident;
sensing when a victim has logged onto the homepage;
sequentially providing a series of information gathering interactive screens on the homepage portal, and reading when each screen has been answered and submitted by the victim;
associating at least one identifier with each report, said identifier being appended to each screen page data block as it is submitted, whereby said victim's identity remains unknown;
storing each screen page data block;
assembling an entire report from the individual screen page data blocks stored;
storing each newly assembled report in a report database;
comparing each newly assembled report with every report in the report database;
determining if there is a duplication of facts between respective reports; and
generating a crime pattern report from said determined duplication, while masking sensitive perpetrator information.

9. The method of claim 8, wherein the step of associating at least one identifier includes the step of generating a first identifier in a string of randomly chosen characters and generating a second identifier in a string of randomly chosen characters, and associating both identifiers with each page data block submitted.

10. The method of claim 9, said storing each screen page data block includes generating an encrypted identifier for each page data block from the two identifiers, masking the two identifiers, masking sensitive perpetrator information, and storing each such page data block in a separate randomly selected temporary storage location.

11. The method of claim 10, also including periodically monitoring each temporary storage location for newly deposited page data blocks and retrieving each page data block, decrypting the encrypted identifier for each page data block, re-associating the first and second identifiers with each page data block, and wherein assembling an entire report includes grouping page data blocks according to the first and second identifiers associated therewith and storing an assembled report in the report database.

12. The method of claim 11, wherein the step of generating an encrypted identifier includes selecting characters from each of the first and second identifier strings of characters and assembling in a sequence determined by a mathematical algorithm, wherein that algorithm is changed periodically.

13. The method of claim 12, wherein the step of determining if there is a duplication includes assigning each report with a duplicated fact to a first subset of reports, then performing the duplication determining step again with respect to high priority data and assigning each such report to a second subset of reports, then performing the duplication determining step again with respect to medium priority data and assigning each such report to a third subset of reports, then performing the duplication step and subset assignment repeatedly until duplication no longer exists.

14. The method of claim 13, wherein the generating crime pattern report includes analyzing the results the duplication determining steps to determine the frequency of each crime factor.

15. The method of claim 14, wherein the step of analyzing the results of the duplication determining steps includes determining the reliability of the analysis.

16. The method of claim 15 also including a status report available for the victim to independently access.

17. The method of claim 16, also including providing a crime pattern report to appropriate law enforcement agencies in the appropriate reported crime jurisdictions including statistical facts reported on crime category, location, frequency, victim profile, time frame, and reliability of received crime data.

18. A method of anonymously gathering crime incident data from a victim and identifying crime patterns without disclosing sensitive alleged perpetrator information, comprising the steps of:
providing a portal for a crime victim to anonymously file a crime report;
generating at least one identifier for the victim's report;
soliciting crime factual information from the victim;
storing the report with its associated at least one identifier;
comparing facts in each new report with facts in other reports;
determining commonality between reports in successive steps and grouping reports by duplicated facts; and
assembling a crime pattern report from said determined grouped duplicated.

19. The method of claim 18, wherein sensitive perpetrator information is protected until the victim comes forth or the perpetrator confesses.

20. The method of claim 19, also including making available to the victim a status report on the number of similarly reported incidents.
